(19) United States
(12) Patent Application Publication
(10) Pub. No.: US 2024/0002162 A1
(43) Pub. Date: Jan. 4, 2024

(54) ROBOTIC CULLING ASSEMBLY FOR PACKAGE HANDLING

(71) Applicant: James R Moore, II, Louisville, KY (US)

(72) Inventor: James R Moore, II, Louisville, KY (US)

(21) Appl. No.: 17/855,796

(22) Filed: Jul. 1, 2022

(51) Int. Cl. B65G 43/10

(52) U.S. Cl. CPC B65G 43/10; B65G 2203/0216

(57) ABSTRACT

In various aspects and embodiments the system described herein provides a novel robotic culling system employing a plurality of sorting and orienting robotic systems to cull a moving package stream. A wide variety of embodiments and uses may be employed implementing the apparatus and system utilizing a variety of structures without departing from the teachings of this specification.

### BACKGROUND OF THE INVENTION

The system described herein relates generally to an apparatus and method for arranging packages being processed on a conveyor system or the like. The present embodiments more specifically include a novel apparatus employing a plurality of robotic assemblies for orienting, arranging, and culling conveyed packages with no manual input.

In conventional package sorting or culling systems utilized in e-commerce applications packages being conveyed must at some point be inspected by a camera, bar code reader, or similar vision system for package identification and sorting through the system. Typically these prior art systems use some type of vision system or reader to examine each package's label, thereby providing a wide variety of package information to an automated control system used to sort and direct packages to a customer or other end user. Package labels and/or bar codes can provide information including, but not limited to customer names, addresses, transportation information, billing information and delivery options. However, in order to properly read each package label as they are being conveyed the package must be oriented properly on the conveyor. In some instances packages are placed on a conveyor system with the requisite label facing down or otherwise away from the vision system or reader, thereby requiring the package to be reoriented or “culled” before further processing can occur. Accordingly, in high-speed package processing systems a large number of packages must be reoriented during conveying in order to properly read package information and route or otherwise sort them.

Some prior art systems simply use manual labor to reorient packages, which are simply positioned by hand as the packages are being conveyed. Obviously these systems require constant human attention and are prone to slow-downs and errors when multiple mis-oriented packages require repositioning in a short span of time. Some systems utilize a package handling robot to lift and reorient packages but these often employ “sort-by-light” systems that require a single robot to turn away from the conveyor or work area, thereby often overwhelming the speed of the robot.

Accordingly, one disadvantage with prior art package sorting systems is the ability to provide high throughput sorting in an automated system. Another disadvantage of prior art systems is their relative inability to accept and sort a plurality of packages from multiple flow streams such as a plurality of converging conveyor systems. Additionally, many prior art systems are incapable of orienting packages on the fly, or while moving.

Accordingly, there is a need for an automated package culling system that overcomes the many disadvantages of the prior art.

In some aspects and embodiments the robotic culling system include a plurality of high-speed robotic package orienting robots to pick and place packages while the packages are moving on a conveyor belt. A plurality of robots may be oriented at various locations around a sorting area on a conveyor without departing from the scope of the embodiments disclosed.

In various embodiments and aspects system disclosed herein utilizes a terminal robot for orienting or otherwise sorting any packages that may be “missed” or skipped by the plurality of robots upstream of the terminal robot.

As used herein for purposes of the present disclosure, the term “robot” can be used to refer to any automated, computer controlled package sorting apparatus that is capable of accessing and orienting a moving package of a predetermined size. Any of a wide variety of robots may be utilized with the concepts and embodiments of the invention as taught herein without limiting the scope of the claims appended hereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other advantages and features, which characterize the embodiments, are set forth in the claims appended hereto and form a further part thereof. However, for a better understanding of the embodiments and of the advantages and objectives attained through their use, reference should be made to the Drawing Figures and to the accompanying specification, in which there are described exemplary embodiments. This summary is merely provided to introduce a selection of concepts that are further described below in the detailed description, and is not intended to identify key or essential features of the claimed subject matter, nor is it intended to be used in limiting the scope of the claimed subject matter.

### BRIEF DESCRIPTION OF THE DRAWING FIGURES

In the drawings, like reference characters generally refer to the same parts throughout the different views. Also, the drawings are not necessarily to scale, emphasis instead generally being placed upon illustrating the principles of the various embodiments.

FIG. 1 is a perspective view of package culling system positioned around a conveyor in accordance with various embodiments; and

FIG. 2 is a flow chart of a package culling system in accordance with various embodiments.

### DETAILED DESCRIPTION OF THE PREFERRED EMBODIMENT(S)

Numerous variations and modifications of the apparatuses and embodiments of the disclosed invention will be apparent to one of ordinary skill in the art, as will be readily seen from the detailed description of the system set forth below. Therefore, the invention is not limited to the specific implementations discussed herein.

Furthermore, the embodiments discussed herein will focus on the implementation of the described techniques and apparatuses for a robotic system for sorting and culling packages. While the embodiments described herein will refer generally to implementation of a robotic package sorting and culling system one of ordinary skill will recognize that the invention may be practiced with a broad array of automated, mechanically controlled structures and components without departing from the scope thereof.

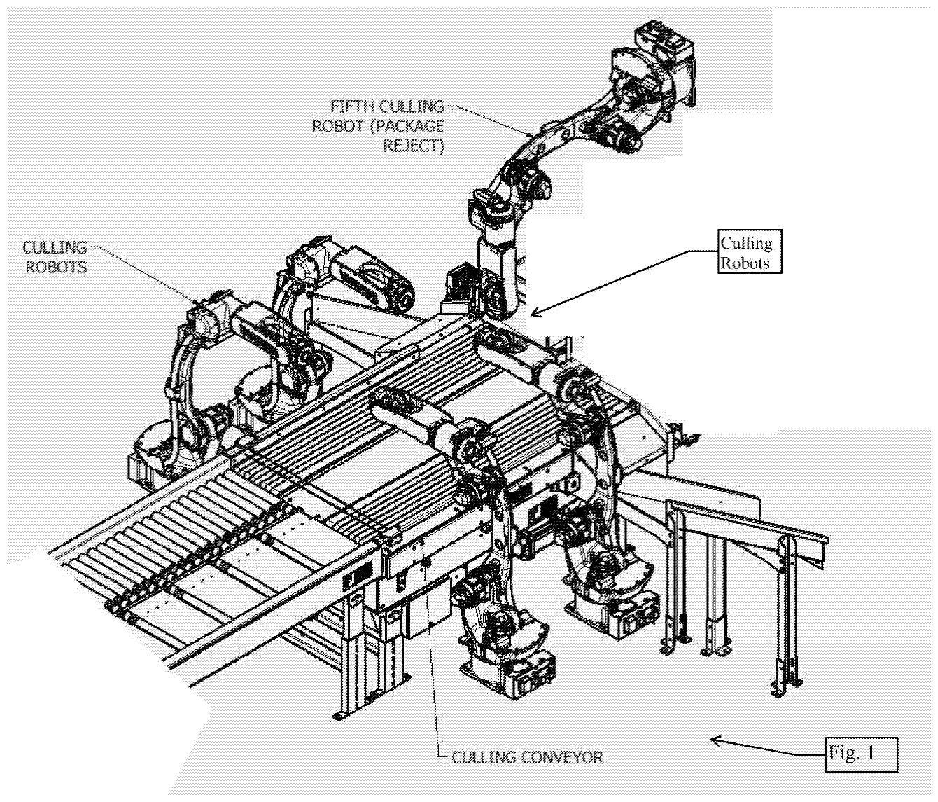

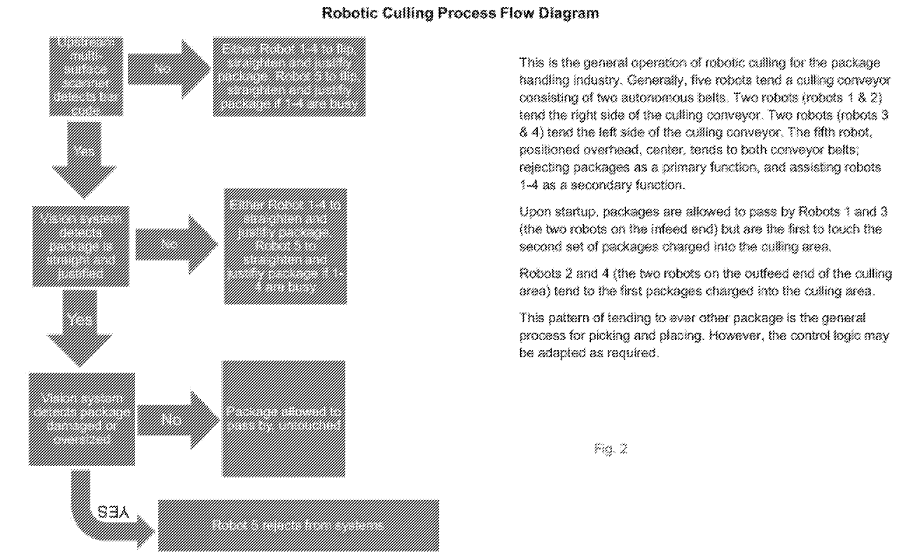

Referring now to drawing FIGS. 1-2 and in accordance with various aspects and embodiments, herein is described a novel culling and sorting system for sorting and orienting packages. One of ordinary skill in the art will recognize that a wide variety of components and structures may be employed in conjunction with the embodiments without departing from the scope thereof. For example, the embodiments described herein are capable of being employed and/or adapted for use in a conventional package conveyor, as depicted in FIG. 1. However, many other embodiments and uses may be employed implementing the apparatus and system utilizing a variety of structures without departing from the teachings of this specification.

The package culling and sorting system embodiments disclosed herein are suited for use with a package conveyor, or a plurality thereof, and is situated proximate the conveyor or conveyors. As seen in FIG. 1 a plurality of arm-style robots, each articulatable in three dimensions and having a terminal end for grasping or otherwise orienting packages being conveyed are positioned proximate a conveyor in various locations to enable each robot to access and position or otherwise orient packages being conveyed. In some exemplary embodiments the plurality of robots are positioned on each long side of a conveyor, and a one of said robots is positioned near the outlet or downstream end of the conveyor for rejecting packages or orienting packages the remaining robots have missed or failed to properly position. In some embodiments the system includes five robots; a pair of spaced sorting robots on each length of the conveyor and a fifth culling robot positioned proximate the outlet of the conveyor. The orientation of robots depicted in FIG. 1 is exemplary. A wide variety of orientations of the plurality of arm-style robots are possible without departing from the scope of the claimed embodiments.

Referring again to FIGS. 1 and 2 in various embodiments the system includes a vision system, or a plurality thereof, operatively coupled to a controller. In further embodiments each sorting and culling robot includes a dedicated vision system for identifying packages present on a conveyor and their orientation relative to a desired predetermined orientation. Each vision system is operably coupled to a controller, as is each robot. The controller has a plurality of suitable inputs and outputs for accepting and providing suitable feedback and commands to the plurality of robots, and is suitably programmed with instructions to enable the vision system inputs to control the operation of each individual robot. In some aspects and embodiments the instructions present in the controller enable at least one robot to justify, straighten, flip, or otherwise orient packages according to a predetermined positioning scheme.

In some aspects a bar code scanner or scanners are operatively coupled to the controller and are used to scan shipping labels or other bar codes necessary to route packages through the conveyor system being utilized. In some embodiments bar code scanners are advantageously located proximate the upstream end of the conveyor for scanning packages early in the conveying process. Where a bar code can't be located for a specific package a robot is instructed to flip or reorient the package until the bar code is scanned. In some embodiments a plurality of robots one an upstream end (and either side) of a conveyor may be used to justify, straighten or orient, and flip packages where necessary is indicated by the bar code scanners, while the remaining robots may wait to perform these same tasks when package throughput is high and the two initial robots miss a package.

In many applications a terminal or “end” robot at a point farthest downstream on a conveyor may be used to reject packages that are classified as “reject’ based on a lack of bar code or shipping label, or if they are oversized or damaged as determined by a vision system. In some aspects the terminal robot may be utilized to justify, straighten, and otherwise orient packages that may have been missed by the other robots in the process flow. This feature of the invention permits a higher rate of package flow through the system than known prior art systems.

Referring now to FIG. 2, in some embodiments a conveyor may comprise a plurality of autonomous conveyor belts, for example, a pair of belts. In these embodiments a pair of sorting robots are positioned on each side of the conveyor, proximate each belt, while a fifth culling robot is positioned at a point downstream of the other robots. An upstream positioned bar code scanner is initially queried to determine whether a bar code for an individual package is detected. When a bar code is detected, a vision system determines whether that package is oriented within a predetermined range of acceptable positions. If not, a one of the four robots is assigned to straighten and justify the package. Where a first robot is already in use the system assigns the second, third, fourth, or fifth depending upon availability.

In situations where a bar code is not detected, a one of the four robots is assigned to flip the package prior to orienting, straightening, or justifying. Where a first robot is already in use the system assigns the second, third, fourth, or fifth depending upon availability. Where the vision system detects a defective package—no bar code, damaged, or oversized—the terminal robot rejects the package by removing it from the conveyor for further processing.

In some aspects and embodiments upon startup of the system the controller instructs the two most upstream robots to let the initial packages pass to the second two robots, and then are assigned to the second set of packages introduced to the conveyor system. In this system each robot on each side of the conveyor will be assigned to handle every other package, thereby increasing system throughput.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The system described herein is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

While the present system has been shown and described herein in what are considered to be the preferred embodiments thereof, illustrating the results and advantages over the prior art obtained through the present system, the system is not limited to those specific embodiments. Thus, the forms of the system shown and described herein are to be taken as illustrative only and other embodiments may be selected without departing from the scope of the thereof, as set forth in the claims appended hereto.

I claim:

1. A package culling system for use with a conveyor having first and second conveyor belts, each of said belts having an upstream end for accepting packages and a downstream end for discharging packages comprising:
a multi-surface bar code scanner for detecting a bar code on each of said packages;
a vision system for detecting the orientation of each of said packages on said conveyor;
a plurality of culling robots for repositioning a package where a bar code is not detected thereon; and
at least one package rejection robot for removing a rejected package from said conveyor prior to discharge thereof.

2. The apparatus of claim 1 wherein said plurality of robots straighten and justify each package on said conveyor.

3. The apparatus of claim 1 wherein said rejection robot operates to straighten and justify a package on said conveyor when said plurality of robots are engaged with other packages.

4. The apparatus of claim 1 wherein said plurality of robots comprises a first pair of robots positioned proximate said first conveyor belt and a second pair of robots positioned proximate said second conveyor belt.

5. The apparatus of claim 4 wherein said rejection robot is positioned proximate the discharge of said first and second belts.

6. The apparatus of claim 4 wherein two robots permit packages to pass untouched to the other two robots for straightening and justification.

7. The apparatus as claimed in claim 4 wherein every other package on a belt is selected by a one of said robots for positioning and justification.

8. The apparatus as claimed in claim 1 wherein said rejection robot removes packages that exceed a predetermined size as verified by said vision system.

9. The apparatus as claimed in claim 1 wherein said rejection robot removes packages that exceed a predetermined weight as verified by said bar code scanner.

10. The apparatus as claimed in claim 4 wherein said two pairs of robots alternate positioning packages depending upon the package flow rate and timing.
